(19) United States
(12) Patent Application Publication
(10) Pub. No.: US 2004/0095741 A1
(43) Pub. Date: May 20, 2004

(54) Side-illuminated advertisement board

(76) Inventor: Shao-Hsiung Chen, Sanchung City (TW)

Correspondence Address: RABIN & BERDO, P.C., Suite 500, 1101 14th STREET, N.W., Washington, DC, 20005, US

(21) Appl. No.: 10/293,480

(22) Filed: Nov. 14, 2002

(51) Int. Cl. F21V 7/05; G09F 13/18

(52) U.S. Cl. 362/31; 40/546; 362/812; 362/307

(57) ABSTRACT

A structure of an advertisement board is disclosed. The advertisement board comprises a case, a display module, two illumination modules and a power supply module. The display module comprises a transparent element having the advertisement pattern and/or letters thereon, and a reflection layer positioned on a back surface of the transparent element. The light from the illumination modules and/or an external source such as, sunlight, enters the transparent element from the sides and get reflected by the reflection layer to clearly display the advertisement pattern and/or letters. Thus the advertisement board of the present invention not only has a capability to perform excellent display functions but also has the capability to reduce the power consumption.

### BACKGROUND OF THE INVENTION

1. Field of the Invention

The present invention relates to a structure of an advertisement board, and more particularly relates to a side-illuminated advertisement board comprising a light guiding element that comprises a display module to guide the light emitted from a lighting module into the transparent element which comprises a high light converging capability and generates a saturated and soft refraction effect, providing the advertisement board with a best refracted and transparent effects with the least of light energy for emphasizing the pattern or letter on the display face.

2. Description of the Related Art

The advertisement boards that are available in the market typically comprises a case, a display surface made of a plastic material covering the case forming a display surface which comprises letters and/or patterns made of acrylic material, and with an illumination device positioned within the case for illuminating the advertisement board. Light from other source would easily interfere the display effect of the advertisement board. Further, since the light emitted by the illumination device is not projected on the pattern and/or letters therefore the contrast effect is not good. Furthermore, since the light source is solely used for illuminating the advertisement board, in other words, since reflective or refraction devices are not included to conserve the optical energy, therefore this would need more powerful light source, thus the power consumption is substantially high. When the illumination device breaks down, the advertisement board cannot display the pattern and/or letter.

Some other types of advertisement board use neon tubes as light source the nighttime display purpose, however the power source of the neon tube is a high voltage and therefore has no economic advantage. Further, even though the neon displays are quite contrasting and attractive even during the daytime, however the manufacturing cost of the neon tube is high and also due to the fact that the neon tube cannot be easily replaced makes the use of neon tubes unattractive.

Accordingly, an improvement of conventional advertisement board in a manner to improve the display effects by improving the contrast and brightness of the display and at the same time, lower cost of the advertisement in terms of manufacture and operation compared to that of a conventional advertisement board is highly desirable.

### SUMMARY OF THE INVENTION

Accordingly, in the view of the foregoing, the present inventor makes a detailed study of related art to evaluate and consider, and uses years of accumulated experience in this field, and through several experiments, to create a structure of a side-illuminated advertisement board of the present invention. The present invention provides an innovated cost effective side-illuminated advertisement board which is capable of displaying the pattern and/or letter on the display surface with excellent contrast and brightness at an expense of low power consumption compared to the conventional advertisement board.

In order to achieve the above objects and other objects of the present invention, a structure of an advertisement board is provided. The advertisement board comprises a case, a display module, two illumination modules and a power supply module. The case is a hollow frame comprising a transparent plate assembled on a frontal side, and a bottom plate secured at a bottom side by a plurality of fixing elements.

According to an aspect of the present invention, the display module comprises a transparent element with pattern and/or letters formed thereon and a light guiding element is fixed within the transparent element, a base color layer is positioned on a frontal side and a rear side of the light guiding element. The light guiding element comprises two reflection layers on an inner surface. A transparent layer is positioned in between the two reflection layers. The shape of the transparent element may be in a form of a layer, wherein the transparent element forms in an orderly fashion from an inner side to an outer side as the refraction layer.

According to another aspect of the present invention, the transparent layer and the projection layer, the transparent element is made of cyclic oxide resin, a soft silicon latex material in which a variety of color pigments can be included to make the transparent element having features like excellent plasticity, attractive colors and high degree of transparency, suitable for fitting a variety of sizes of patterns and letters, and compatible with a wave length and/or refraction frequency of a variety of light sources and a variety of light sources can be interchangeably used. Thus the transparent element can be manufactured with a high degree of transparency having a desired attractive colored layer designed suitably to fit into an advertisement board of a certain dimension.

According to another aspect of the present invention, the illumination module comprises a positioning set, a base and a circuit board. A power supply module supplies power to the circuit board. The circuit board controls an array of light emitting elements, which is positioned on the circuit board to perform spotting, flashing or other variety of glowing operation mode in accordance with program set in the circuit board. The light emitting element comprises preferably an ultra-bright four-element light emitting diodes (Ultra Bright LED) secured onto circuit board. The circuit board is secured onto the base and the base is secured onto positioning set by using a plurality of fixing elements. Two positioning sets are respectively positioned inside an upper portion and a lower portion of the case. The light emitted by the light emitting elements project straight onto the transparent element and enters from the upper and bottom part of the transparent element.

According to another aspect of the present invention, the light glowed by the light emitting element projects from the upper and lower side of the light guiding element of the display module to the transparent element, and since the reflection layer and the base color layer are positioned at the frontal and rear side of the transparent element, therefore all of the light from the transparent layer enters into the transparent layer from the sides. According to the optical co-vibration theory, a best co-vibration effect can be achieved by transmitting the light through a transparent media. Because a color contrasting reflection layer is positioned on a back surface of the transparent element, therefore light will be reflected to provide the best effect on the projection layer, thus with a least light energy a best refraction result can be achieved.

### BRIEF DESCRIPTION OF THE DRAWINGS

For a more complete understanding of the present invention, reference will now be made to the following detailed description of preferred embodiments taken in conjunction with the accompanying drawings, in which:

FIG. 1 is an exploded view of an advertisement board of the present invention;

FIG. 2 is an elevational view of the advertisement board of the present invention;

FIG. 3 is a sectional side view of the advertisement board of the present invention; and

FIG. 4 is an embodiment of the advertisement board showing the refraction of light from the transparent element according to the present invention.

### DESCRIPTION OF THE PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

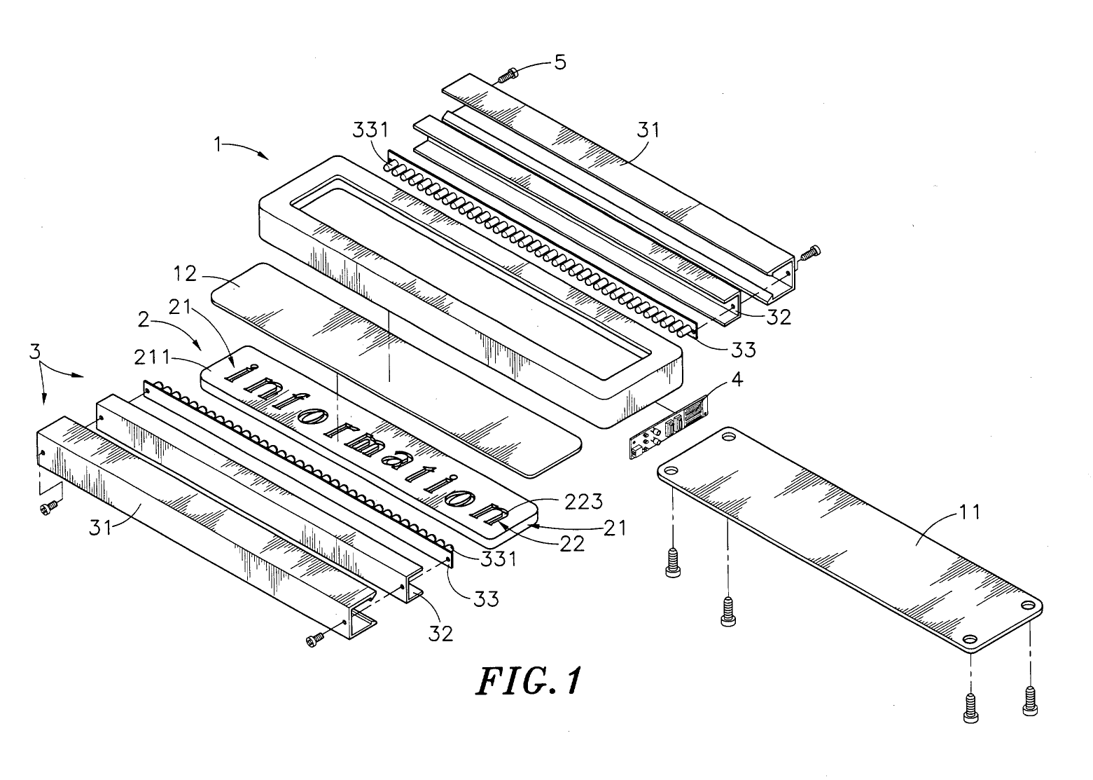

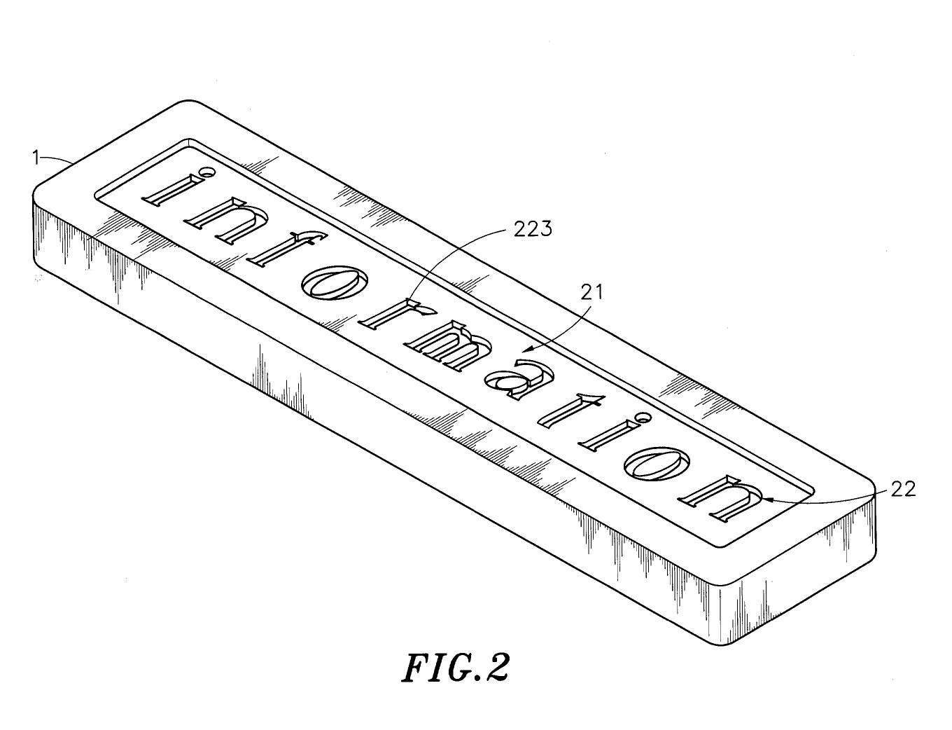

Referring to FIGS. 1 and 2, the advertisement board of the present invention comprises a case 1, a display module 2, two illumination modules 3 and a power supply module 4. The case 1 is a hollow frame comprising a transparent plate 12 assembled on a frontal side, and a bottom plate 11 secured at a bottom side by a plurality of fixing elements 5.

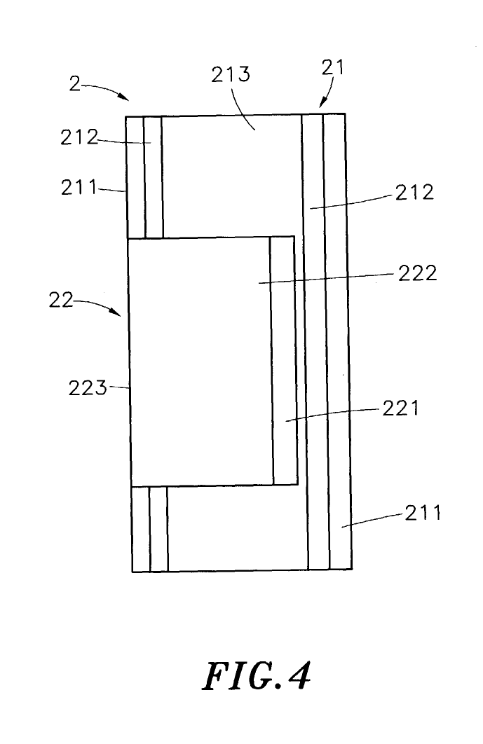

The display module 2 comprises a transparent element 22 with pattern and/or letters formed thereon and a light guiding element 21 is fixed within the transparent element 22, a base color layer 211 is positioned on a frontal side and a rear side of the light guiding element 21. The light guiding element 21 comprises two reflection layers 212 on an inner surface. A transparent layer 213 is positioned in between the two reflection layers 212. The shape of the transparent element 22 may be in a form of a layer, wherein the transparent element 22 forms in an orderly fashion from an inner side to an outer side as the refraction layer 221, the transparent layer 222 and the projection layer 223 (as shown in FIG. 4). The transparent element 22 is made of cyclic oxide resin, a soft silicon latex material in which a variety of color pigments can be included to make the transparent element 22 having features like excellent plasticity, attractive colors and high degree of transparency, suitable for fitting a variety of sizes of patterns and letters, and compatible with a wave length and/or refraction frequency of a variety of light sources and a variety of light sources can be interchangeably used. Thus the transparent element 22 can be manufactured with a high degree of transparency having a desired attractive colored layer designed suitably to fit into an advertisement board of a certain dimension.

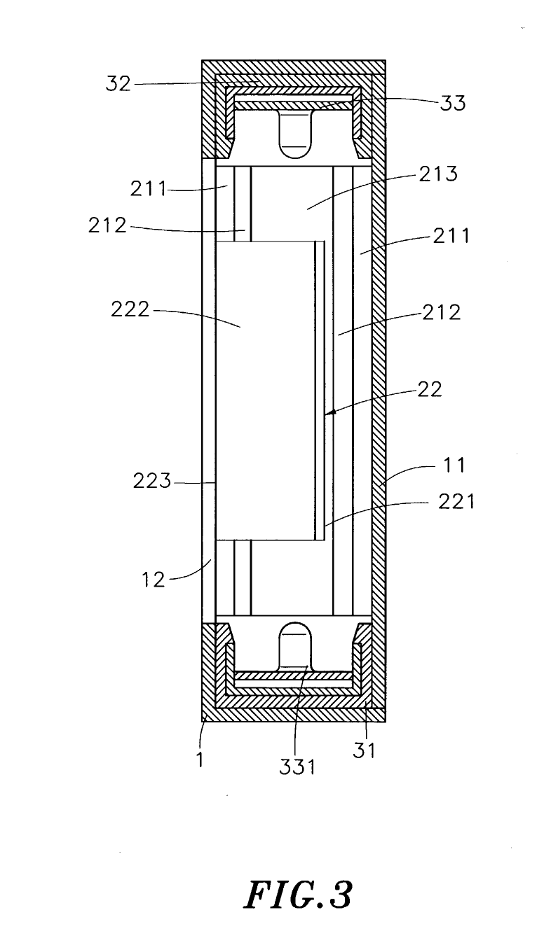

Each of the illumination modules 3 comprises a positioning set 31, a base 32 and a circuit board 33. A power supply module 4 supplies power to the circuit board 33. The circuit board 33 controls an array of light emitting elements 331 which is positioned on the circuit board 33 to perform spotting, flashing or other variety of glowing operation mode in accordance with program set in the circuit board 33. The light emitting element 331 comprises preferably an ultra-bright four-element light emitting diodes (Ultra Bright LED) secured onto circuit board 33. The circuit board 33 is secured onto the base 32 and the base 32 is secured onto positioning set 31 by using a plurality of fixing elements 5. Two positioning sets 31 are respectively positioned inside an upper portion and a lower portion of the case 1. The light emitted by the light emitting element 331 projects straight onto the transparent element 22 (as shown in FIG. 3) and enters from the upper and bottom part of the transparent element 22.

Referring to FIGS. 3 and 4, show an embodiment of refraction of the transparent element of the present invention. The light glowed by the light, emitting element 331 projects from the upper and lower side of the light guiding element 21 of the display module 2 to the transparent element 22, and since the reflection layer 212 and the base color layer 211 are positioned at the frontal and rear side of the transparent element 22, therefore all of the light from the transparent layer 213 enters into the transparent layer 222 from the sides. According to the optical co-vibration theory (the wave length of the light emitting from the letters is equivalent or close to that of the light source), a best co-vibration effect can be achieved by transmitting the light through a transparent media (such as the transparent layer 222). Because a color contrasting reflection layer 212 is positioned on a back surface of the transparent element 22, therefore light will be reflected to provide the best refraction effect on the projection layer 223, thus with a least light energy a best refraction result can be achieved.

The features of the side-illuminated advertisement board of the present invention are:

1. By using a cyclic oxide resin for making the transparent element 22, the transparent element 22 having higher degree of plasticity and transparency can be achieved. This would also reduce manufacturing cost compared to the processing time required carving on the conventional acrylic board.

2. By positioning the reflection layer 212 on a back surface of the transparent element 22, the advertisement board not only provides an improved contrast display features but also substantially reduces the power consumption, thus with the least light energy a best contrast effect can be achieved.

3. By positioning the reflection layer 212 on a back surface of the transparent element 22, the light from an external source, such as sun light or other light source other than the light emitting elements 331, enters the transparent element 22 and get reflected to clearly display the advertisement pattern and/or letters on the transparent element 22, thus the advertisement board of the present invention also has the capability to perform display functions using sun light without having the light emitting elements 331 turned on, and therefore the power consumption for outdoor advertisement board can be substantially reduced. Thus, the life-time of the advertisement board can be effectively extended.

4. Because the advertisement board of the present invention uses the light emitting elements 331 project light towards the upper and lower part of the light guiding element 21 of the display module 2, and since the reflection layer 212 and the base color layer 211 are positioned at the frontal and rear side of the transparent element 22, therefore the light from the transparent layer 213, and all of the remaining light enters and transmit through the transparent element 22 from the sides. Thus this arrangement can effective reduce the optical energy loss.

While the invention has been described in conjunction with a specific best mode, it is to be understood that many alternatives, modifications, and variations will be apparent to those skilled in the art in light of the a foregoing description. Accordingly, it is intended to embrace all such alternatives, modifications, and variations, which fall within the spirit and scope of the included claims. All matters set forth herein or shown in the accompanying drawings are to be interpreted in an illustrative and non-limiting sense.

What the invention claimed is:

1. A side-illuminated advertisement board, comprising:
a case,
an illumination module positioned inside the case,
a display module positioned on a front side of said display module faces a transparent plate of said case, wherein said display module comprises a transparent element positioned inside a light guiding element, and wherein said transparent element comprises a refraction layer, a transparent layer and a projection layer; and
a power supply module for supplying power to said illumination module to enable a light emitting element of said lighting module to emit light to a side of said display module, wherein the light emitted by the light emitting element is guided from the light guiding element to enter the transparent layer from a side transmit through the transparent element so that an emergent light having a co-vibration effect is achieved, and wherein a reflection layer is positioned on the back surface of said transparent element to reflect and converge a light, and to project a reflected converged light towards the projection layer to produce a refraction effect.

2. The side-illuminated advertisement board according to claim 1, wherein said light emitting element is comprised of an ultra bright four-element light emitting diode (Ultra Bright LED).

3. The side-illuminated advertisement board according to claim 1, wherein said case comprises a hollow frame, a transparent plate assembled on the frontal surface, and a bottom plate is secured at a bottom surface of said case by using a plurality of fixing elements.

4. The side-illuminated advertisement board according to claim 1, wherein said display module comprises a base color layer disposed on a frontal side and a rear side of said light guiding element, wherein two reflection layers are disposed inside said light guiding element, and wherein a transparent layer is positioned in between said two reflection layers.

5. The side-illuminated advertisement board according to claim 1, wherein the shape of said transparent element of said display module is arranged in a form of patterns and/or letters.

6. The side-illuminated advertisement board according to claim 1, wherein said lighting module comprises a positioning set, a base and a circuit board, and wherein said circuit board comprises an array of light emitting elements.
